(19) United States
(12) Patent Application Publication
(10) Pub. No.: US 2005/0273553 A1
(43) Pub. Date: Dec. 8, 2005

(54) System, apparatus, and method for content management

(76) Inventor: John Boucard, Pasadena, CA (US)

Correspondence Address: Robert E. Krebs;THELEN REID & PRIEST LLP, P.O. Box 640640, San Jose, CA, 95164-0640, US

(21) Appl. No.: 11/105,183

(22) Filed: Apr. 12, 2005

Related U.S. Application Data
(60) Provisional application No. 60/562,027, filed on Apr. 13, 2004.

(51) Int. Cl. G06F 12/00

(52) U.S. Cl. 711/112

(57) ABSTRACT

A system for managing a content of a storage medium comprising a media player, a controller, a wireless input device. The media player has access to a media content in a storage medium. The controller is coupled to the media player. The wireless input device wirelessly interfaces with the controller. The controller directly selects a selected content segment from the storage medium in response to the wireless input device associated with the selected content segment.

### CROSS-REFERENCES TO RELATED APPLICATIONS

The present application claims the benefit of U.S. Provisional Patent Application Ser. No. 60/562,027, filed Apr. 13, 2004.

### FIELD OF THE INVENTION

The present invention relates to an interactive content management system selectively activating digital content. More particularly, the present invention relates to device and method for specifically activating relevant digital media elements.

### BACKGROUND OF THE INVENTION

Content distributed on VCD or DVD media has traditionally been viewed and listened to on a television set by way of a specific media player such as a DVD player or VCD Player. Usually audio and video content located on the CD/DVD/VCD are organized by specific menus and selectively accessed by a separate infrared remote control. The IR Remote has specific buttons that allow the user to navigate through a hierarchal menu structure. At the point where the user makes a decision to view and listen to a specific of content, he/she activates the remote control and waits for the content to be displayed on a television set. The user usually watches and listens to the content being processed by the specific content player (VCD/DVD) through a television set.

What is therefore needed is an interactive content management system where specific pieces of content are instantaneously accessed by external devices where users may not necessarily require the use of the current hierarchical menu structures and navigation by a standard infrared remote control.

### BRIEF DESCRIPTION OF THE INVENTION

A system for managing a content of a storage medium comprising a media player, a controller, a wireless input device. The media player has access to a media content in a storage medium. The controller is coupled to the media player. The wireless input device wirelessly interfaces with the controller. The controller directly selects a selected content segment from the storage medium in response to the wireless input device associated with the selected content segment.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram schematically illustrating a front view of a multi media device in accordance with one embodiment.

FIG. 2 is a diagram schematically illustrating a rear view of a multimedia device in accordance with one embodiment.

FIG. 3 is a diagram schematically illustrating a top view of a multimedia device in accordance with one embodiment.

FIG. 4 is a block diagram schematically illustrating a system for managing a content of a content media in accordance with one embodiment.

FIG. 5A is a block diagram schematically illustrating a wireless input device in accordance with one embodiment.

FIG. 5B is a block diagram schematically illustrating a wireless input device in accordance with another embodiment.

FIG. 5C is a block diagram schematically illustrating a wireless input device in accordance with another embodiment.

FIG. 6A is a block diagram schematically illustrating a receiver wirelessly interfacing with a wireless input device in accordance with one embodiment.

FIG. 6B is a block diagram schematically illustrating a receiver wirelessly interfacing with a wireless input device in accordance with another embodiment.

FIG. 7A is a diagram schematically illustrating a media player coupled to a storage medium in accordance with one embodiment.

FIG. 7B is a diagram schematically illustrating a media player coupled to a storage medium in accordance with another embodiment.

FIG. 7C is a diagram schematically illustrating a media player coupled to a storage medium in accordance with another embodiment.

FIG. 8 is a flow diagram illustrating a method for media content management in accordance with one embodiment.

### DETAILED DESCRIPTION

Embodiments of the present invention are described herein in the context of media content management. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

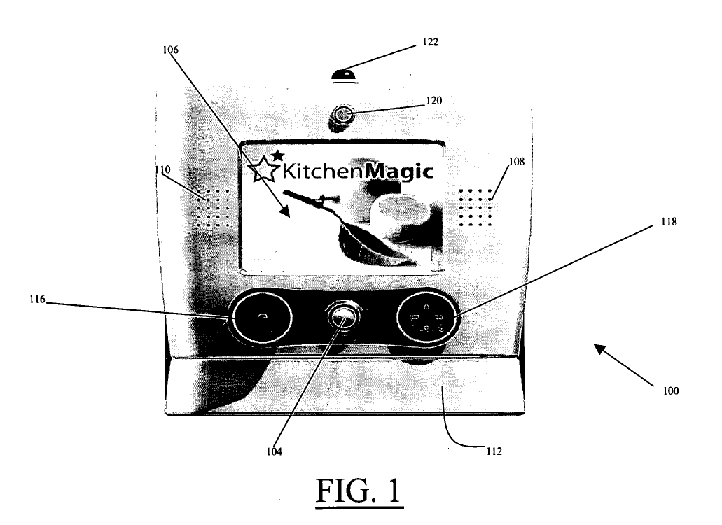

FIGS. 1, 2, and 3 illustrate an example of an interactive inventory tracking, content, and operations management system. A centralized hub device 100 enables users to keep track of inventory of items, manage content within or external to the device 100, and hels facilitate other operations. In accordance with one embodiment, device 100 uses external tracking devices (described in more details below) to maintain an automatic inventory account of various items. Its content management software is application specific, with the actual content varying depending on the intended use of device 100. The operations management system of device 100 allows for operations control of various external devices as well (described in details below). Device 100 may be used in homes, restaurants, hospitals, or any facility that requires accurate inventory tracking system, content management, and operations management of the facility. For illustrative purposes, at home, device 100 may allow a user to decide the type of food a person can prepare based on the availability of inventoried items (including food and utensil items available at home), provide content regarding a specific recipe, and help in the actual operations of cooking by remotely controlling various cooking parameters such as temperature and/or time.

The interactive content management aspect of the device enables instantaneous access to specific pieces of media content by external devices without using any hierarchical menu structures or navigation. Device 100 has the ability to activate specific piece of media content using wireless devices, audible voice (voice activation), and other input schemes such as a wireless connection to a computing device such as a PDA or others, including the World Wide Web or the Internet.

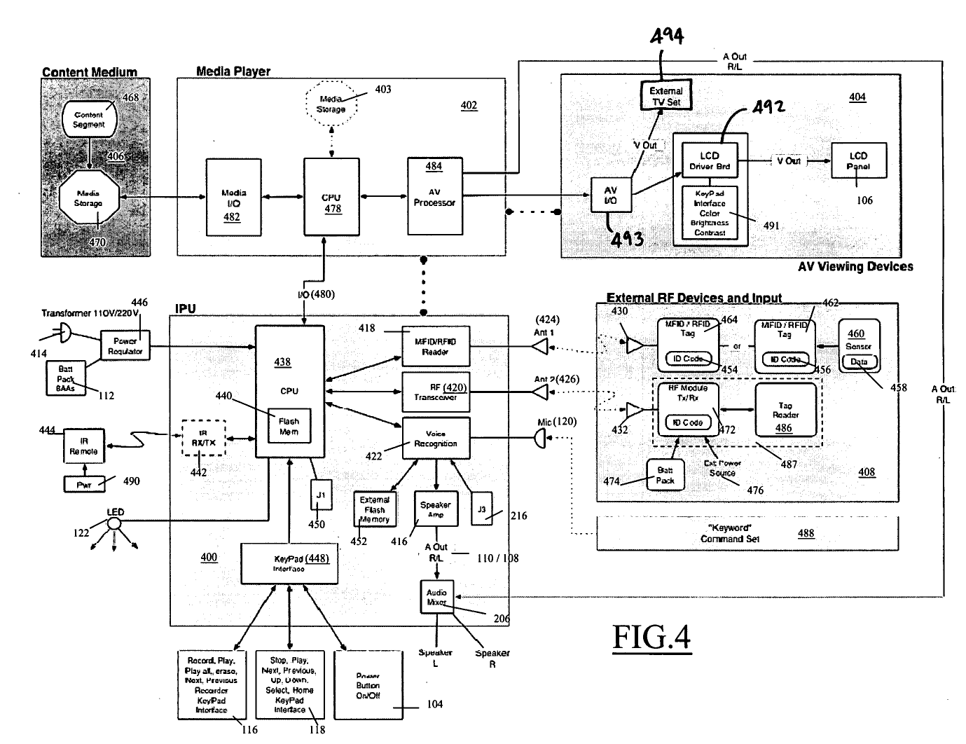

The front section of device 100 include an ON/OFF activation mechanism 104 that enables users to activate/de-activate the system. Although illustrated as a simple switch, the functionality of the ON/OFF activation mechanism 104 may be accomplished by other methods such as voice activation and others. An external battery pack within housing space 112 powers device 100. Device 100 may also be connected to a power outlet via a mating plug (see power plug 414 in FIG. 4). Device 100 also includes a power source jack (not shown) accommodating a power adapter 446 for connection to a wall outlet that may be used to power device 100 or recharge batteries located in housing 112 through a conventional recharging circuit (not shown). This enables device 100 to operate using the batteries enclosed in housing 112 and/or using the AC power from an outlet through the AC to DC power adapter 446. In addition, device 100 may use or supply power to portable handheld devices (e.g. PDAs) through an appropriate connection (not shown).

The front interface console of device 100 also comprises a navigation dial 116 and a navigation keypad 118, enabling users to directly select content and allow controlled direct access to content through possible menus that display on the audio/video AV viewing LCD Screen 106. The functionality and use of both navigational dial 116 and navigation keypad 118 are well known in the art. Navigational dial 116 may rotate clockwise or counter clockwise and be pressed for quick selection of possible on screen menu items, and to set digital timers. Navigation keypad 118 has shortcut keys that allow access to various “modes” of device 100 such as voice record mode, main menu, help, menu up, etc. A microphone 120 on device 100 provides the means for the voice-activation functionality using keyword command sets by users. Microphone 120 in conjunction with keypad 118 allows user the ability to record their own voice and store it in the device 100 memory or a voice recognition's external memory. As an example, his function (using the keypad 118) is useful when the user desires to record a shopping list and play back the list at any time.

Device 100 further comprises a pair of speakers (right speaker 108, left speaker 110) to allow audio output of selected content. The speakers may comprise of standard magnetic audio devices or comprise of headphones. Device 100 may also include an earphone jack (not shown) and personal earphones (not shown) to enable users to hear the audio output. A Light Emitter Diode (LED) 122 on device 100 functions as an indicator for system operations. In accordance with one embodiment the tri colored LED 122 is able to change colors based on the various types of RF wireless processing, voice command activation and interpretation (e.g. LED may turn red if CPU or the voice recognition process does not understand the voice commands being transmitted to the unit). LED 122 also turns into different colors on power up, shut down, and if a second device with any number of RF external devices is communicating with the device 100.

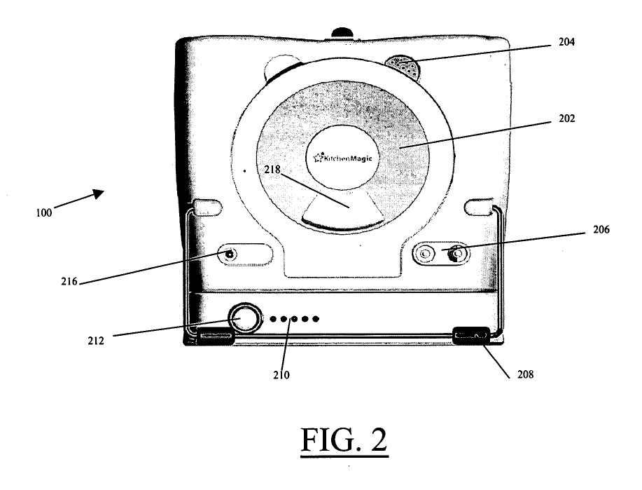

FIG. 2 illustrates the back section of the device 100, illustrating a well-known reader mechanism (media player 402 in FIG. 4) for reading content stored on an appropriate portable storage medium. A reader mechanism door 202 opens through a well-known unlocking mechanism 204 for insertion of an appropriate removable storage medium therein. Reader mechanism door 202 also includes a viewer window 218, allowing users to see inside the reader mechanism 402 without opening door 202. Further illustrated in the back section of device 100 are various media outlet jacks 206 used for outputting content onto a television, other media players, computing devices such as PDAs, personal computers, or the Internet. A network outlet jack 216 enables device 100 to connect to the Internet to allow for downloading of content. Although not shown, device 100 may, in addition, include a Universal Serial Buss (USB) connector that allows for downloading/uploading of content to be stored internally and played at will, or content to be streamed live to device 100 from an outside source, for example, content directly downloaded from the Internet or the World Wide Web. A set of battery charge indicator LEDs 210 function as a visual indicator for the power remaining within the unit. Pressing a battery charge indicator switch 212 may activate the entire charge indicator LEDs 210 when there is full power. As illustrated, device 100 also includes a kickstand 208 for stability, and a small programming pin-out (not shown) that is located on the back of device 100. A screw (not shown) in door 202 covers this pin-out receptacle.

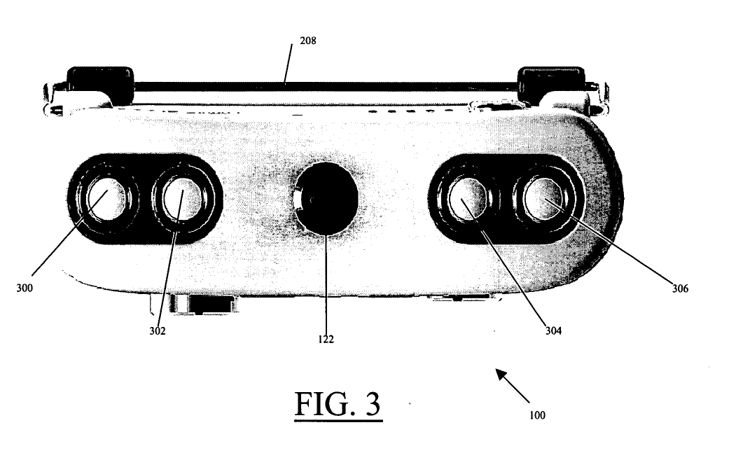

FIG. 3 illustrates the various control interfaces available on device 100. A conventional volume controller 300 may be used to adjust the volume of audio content output from device 100. A brightness controller 302 enables users to adjust the brightness of LCD screen 106. A tint controller 306 enables users to adjust tint on LCD screen 106.

FIG. 4 illustrates a general system overview of the various components of device 100, including additional external devices. As illustrated, device 100 includes a main unit 400, which is the control board of the invention whereby all processing and interpretation of signals related to any external RF wireless devices 408, switch interfacing 448, media player access and control 402, AV viewer control 404, and voice recognition 422 takes place. The main unit 400 is powered by a standard wall outlet plug interfacing with a male connector 414 or an external battery pack 112 with a power regulating circuit 446 converting the input voltage to a proper value for the Central Processing Unit (CPU) 438 and other components on unit 400.

In accordance with one embodiment, CPU 438 has a built in memory 440 that stores the software that interprets and controls CPU functionality as well as other component on main unit 400. The CPU 438 also has the ability to access other memory storage such as external flash memory 452, which is used in case of a need to store additional software where memory 440 does not have sufficient space. In general, software ports to the CPU 438 by a jack 450 in a well-known manner. CPU 438 may receive commands from external keypad interface 448 that may be connected to various membrane switch and/or mechanical switch arrays (116, navigation keypad 118, and power switch 104). The user can activate these mechanisms when desiring to manipulate media content controlled by device 100.

CPU 438 also has the ability to interpret commands from an external IR remote 444 that is powered by a separate power source 490 or a RF Remote 600. CPU 438 processes the IR signal sent to main unit 400 through an IR detector/emitter element 442 or a RF Transceiver 420. Tri-colored LED 122, which is controlled by CPU 438, activates different colors based on input from external RF devices 408 and other input elements (voice recognition 422, dial 116, dial 118, button 104, RF remote 600) to indicate a valid understanding of various types of RF input, voice commands, or input mechanisms (e.g. navigation dial 116, keypad 118, etc.).

A MFID/RFID reader 418 located onboard unit 400 produces a magnetic field through antenna 424 that extracts information from various external RF devices 408. The information extracted may include ID code processed through MFID/RFID reader 418 and sent to CPU 438 for interpretation. CPU 438 looks up in a software table stored in internal memory 440 or external memory 452 and match the specific ID code (or other identifying data) from the external RF devices. The ID code may match with a specific piece of content 468 stored in various types of media storage 470. A media player 402 can access and process specific piece of content 468 to be finally viewed on viewing device 404 and manipulated by main unit 400.

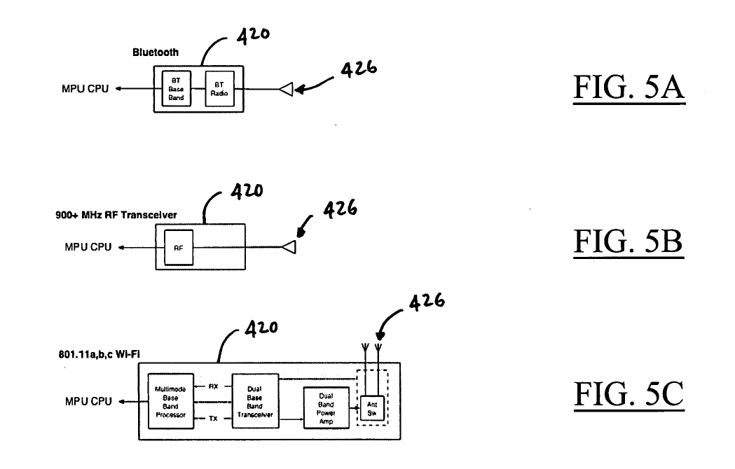

RF Transceiver 420 onboard unit 400 is able to transmit and receive data via antenna 426. Main unit 400 may receive data transmitted from a tag 487. Tag 487 may also include a tag reader 486 and a separate RF Transceiver 472, which may be powered by separate power sources (battery 474, external power source 476). Data captured from external RF Transceiver 472 of tag 487 is first processed by RF Transceiver element 420 and interpreted by CPU 438. The internal firmware onboard memories (440, 452) processes the RF Transceiver data and instruct CPU 478 of media player 402 through digital interface 480 to access media player I/O 482 and retrieve through media storage 470 a specific content segment 468 associated with data captured from tag 487. Content segment 468 is processed by media player CPU 478 and encoded/decoded through media player AV processor 484 and viewed through AV viewing device 404. In accordance with another embodiment, unit 400 may also write specific codes on specific tags via RF transceiver 420. As illustrated in FIGS. 5A, 5B, and 5C, RF transceiver unit 420 may include Bluetooth technology (FIG. 5A), which is a widely accepted standard for wireless communication between devices. It could also include a well known 900 MHz custom frequency RF Transceiver (FIG. 5B). As illustrated in FIG. 5C, RF transceiver 420 could also include an IEEE 802.11a, b, c WI-FI module, enabling device 100 to connect to a series of PCs communicating with device 100. Hence, FIGS. 5A, 5B, and 5C are three well-known exemplary RF solutions that may be used for RF transceiver 420. It should be noted that these solutions are exemplary embodiments, and should not be limiting.

Referring back to FIG. 4, voice recognition unit 422 on unit 400 interprets voice commands spoken by a user through a small microphone 120 to access specific voice recognition software stored on-board voice recognition unit 422 or stored in external flash memory 452. This software is able to recognize specific types of words, trigger phrases, sentences, as well as different languages. These keywords or command sets 488 are tied to specific actions that CPU 438 translates and through digital I/O interface 480 accesses and controls specific pieces of content activated by media player 402 and controlled in tandem by CPU 438 and media player CPU 478. That is, one could access specific pieces of content by merely speaking specific commands to unit 400, which is then processed by voice recognition unit 422 located on main unit 400. A user could literally speak to main unit 400 and activate relevant menu items or instantaneously activate a specific piece of media content 468. Voice recognition unit 422 may also have the ability to store voices as well. Microphone 120 can be used and controlled by CPU 438 to activate recording and a playback function inside the voice recognition unit 422 using navigation keypad 118.

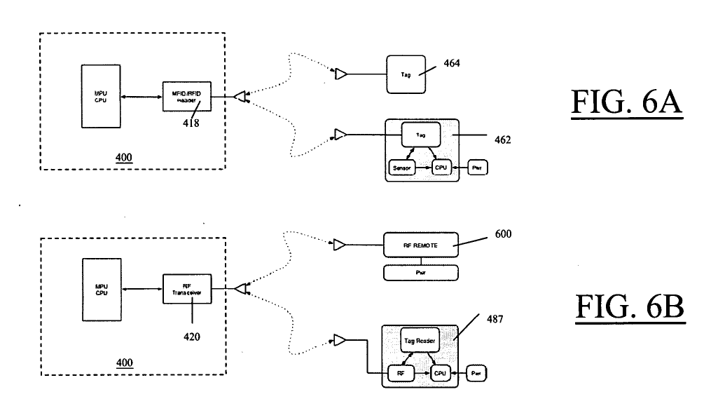

The exemplary external RF wireless devices 408 communicating with main unit 400 are illustrated in detail in FIGS. 4, 6A, and 6B. There are several types of external RF wireless devices 408, which may include but not be limited to RFID/MFID Tags 464, RFID/MFID Tags integrated with sensors 462, RF remote devices 600, and RFID/MFID Reader/Transceiver 487. These exemplary RF devices have the ability to interpret commands by other devices and send specific types of commands to main unit 400 for processing to eventually activate a specific piece of content 468 that is displayed and listened to through AV viewing device 404. RF Transceiver 472 in tag 487 could interface with MFID/RFID tag 462 or 464 whereby an ID Code (454, 456) or data 458 from sensor 460 stored in MFID/RFID Tag 462 could be sent by RF Transceiver 472 within tag 487 to RF Transceiver 420. This could allow “remote” tags 487 with readers 486 to capture ID codes from other tags such as 464, 462 and transmit data to main unit 400 via RF transceiver 472. As an example, there might be a remote MFID/RFID reader/transceiver tag 600/487 in a refrigerator or cabinet in the home that could take inventory of objects with tags 464/462 attached and transmit object data to the main unit 400 for analysis to be processed thereby activating specific types of content via the media player 402 and viewed on an AV viewing device 404. Tags with sensors such as tags 462 may also be placed on cooking utensils to detect temperature using the onboard sensors of the tags when cooking food. Information from tags 462 may then be read by remote readers/transceiver tags 487 and transmitted to RF transceiver 420 of unit 400. The CPU 438 based on content on the storage medium 470 may then alert the user to reduce cooking temperature or simply automatically turn-off heat to the cooking utensil through well-known Electro-mechanical devices.

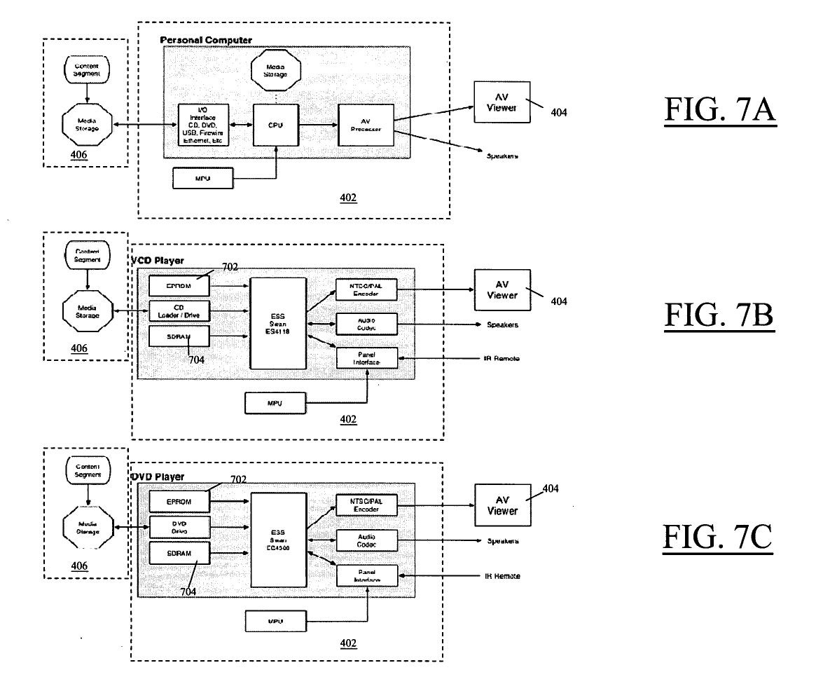

In general, as illustrated in FIGS. 4, 7A, 7B, and 7C, reader mechanism 402 (the media player) could be any device that has the ability to access, playback, and manipulate digital content on a storage medium, including but not limited to DVD players, VCD players, Personal Computers, CD players, MP3 players, Game Boxes, Mobile Phones, Handheld devices, pocket PCs, etc. In general, the reader mechanism 402 includes a device controller (a control chip) that controls the read function of nonvolatile storage unit 470 to extract content segment data 468 stored on external storage medium 470 or an internal storage medium 403. An IDE control interface (or optional memory device) incorporated in an Application Specific Integrated Circuit (ASIC) CPU 478 controls the device controller along with a volatile memory buffer 702, 704 shown in FIGS. 7B and 7C as EPROM and SDRAM. The memory buffer area 702, 704 will be the primary area for pre-processing and buffering video and audio data prior to transfer of data to main unit 400. The ASIC CPU 478 contains all the I/O ports, audio amplifier, IDE interface, buss interface, and any other functionality required by the system. Reader mechanism 402 for such an embodiment is therefore conventional and well known, with similar IDE interface control used to handle most hard derive, removable discs, etc. Reader mechanism 402 may also comprise of a solid state memory unit, with its corresponding controller chip.

When device 100 activates reader mechanism 402, CPU 478 retrieves data from the storage medium 470 in the nonvolatile storage unit. A controller device (or a driver) of reader mechanism 402 receives command signals from the CPU 478 to retrieve (read) data from storage medium 470. Data extracted is placed into volatile memory buffer 702, 704, where CPU 478 retrieves that data and makes it available on interface bus 480 for eventual transfer to unit 400. CPU 478 controls all data decompression, buffering, handshaking and overall logic for reader mechanism 402. Content media 406 may include many different types of storage technologies including but not limited to CD, CD-ROM, DVD, VCD, Audio CD, Removable Flash Memory, External/Internal Hard Drives, Internet Servers, LAN Servers, Extranet File Servers, Firewire drives, USB drives, Compact Flash, SD Cards, Memory Sticks, Smart Media Cards, etc. Content medium 406 may also include stored digital content such as movies, data files, programs, html, flash, animated content, video content, audio content, mp3 files, wav files, aac files, etc, and any type of digital content able to be activated by media player 402.

Referring back to FIG. 4, also included with device 100 is an audio/video (AV) viewing device 404 that includes a display unit 106. AV viewing device 404 could be any well-known apparatus that can output video and audio signals, including but not limited to television sets, monitors, LCD Screens, HDTV sets, mobile phone handset screen, or dot matrix displays. An LCD video driver board 492 is a conventional driver for the LCD display 106. A LCD keypad interface 491 allows external devices such as a coupled television set to be adjusted for contrast, brightness, and others. AV viewing device 404 may also include an audio-video I/O 493 allowing a video output to an external TV set 494.

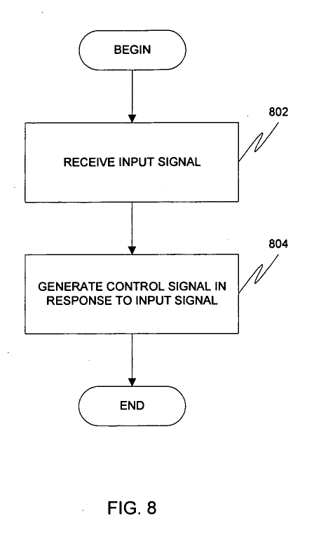

FIG. 8 illustrates a method for selecting a specific multimedia content segment from a storage medium. At 802, a wireless signal is received from a input device in proximity (such as an RFID tag). The wireless input device is associated with the specific multimedia content segment. At 804, a control signal in response to a the wireless input device is generated to directly select the specific multimedia content segment from the storage medium and play it on an AV viewing device.

Different embodiments of the present invention were described herein in the context of an interactive content management system. Those of ordinary skill in the art will realize that the above detailed description of the present invention was illustrative only and is not intended to be in any way limiting. Other embodiments of the present invention will readily suggest themselves to such skilled persons having the benefit of this disclosure.

In the interest of clarity, not all of the routine features of the implementations described herein were shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

1. A system for managing a content of a storage medium comprising:
a media player coupled to the storage medium;
a controller coupled to said media player; and
a wireless input device wirelessly interfacing with said controller,
wherein said controller directly selects a content segment from the storage medium in response to said wireless input device.

2. The system of claim 1 wherein said media player is an optical disc reader.

3. The system of claim 1 wherein said media player is a magnetic disc reader.

4. The system of claim 1 wherein said storage medium is an optical disc.

5. The system of claim 1 wherein said storage medium is a magnetic disc.

6. The system of claim 1 wherein said storage medium is a memory.

7. The system of claim 1 further comprising an audio-video viewing device coupled to said media player.

8. The system of claim 1 wherein said controller further comprises:
a central processing unit;
a user interface input coupled to said central processing unit;
a receiver receiving a wireless signal coupled to said central processing unit,
wherein said central processing unit generates a control signal that selects said content segment to said media player in response to said user interface input and said wireless signal.

9. The system of claim 8 wherein said receiver comprises an RFID/MFID reader.

10. The system of claim 8 wherein said receiver comprises a RF transceiver.

11. The system of claim 8 wherein said receiver comprises a voice recognition module.

12. The system of claim 1 wherein said wireless input device comprises an RFID/MFID tag.

13. The system of claim 1 wherein said wireless input device comprises an RF Module transceiver.

14. A device for managing a content of a storage medium comprising:
a controller directly selecting a specific multimedia content segment from a storage medium in response to a wireless input device in proximity of said controller,
wherein said wireless input device is associated with said specific multimedia content segment.

15. The device of claim 14 wherein said controller further comprises:
a central processing unit;
a user interface input coupled to said central processing unit;
a receiver coupled to said central processing unit, said receiver receiving a wireless signal generated by said wireless input device,
wherein said central processing unit generates a control signal that selects said specific multimedia content segment from said storage medium in response to said wireless signal.

16. The device of claim 15 wherein said receiver comprises an RFID/MFID reader.

17. The device of claim 15 wherein said receiver comprises a RF transceiver.

18. The device of claim 15 wherein said receiver comprises a voice recognition module.

19. The device of claim 15 wherein said wireless input device comprises an RFID/MFID tag.

20. The device of claim 15 wherein said wireless input device comprises an RF Module transceiver.

21. A method for selecting a specific multimedia content segment from a storage medium comprising:
receiving a wireless signal from a wireless input device in proximity; and
generating a control signal in response to said wireless signal, said control signal directly selecting the specific multimedia content segment from the storage medium.

22. The method of claim 20 wherein said wireless input device comprises an RFID tag.

23. The method of claim 20 wherein said wireless input device comprises an RF module transceiver.

24. A program storage device readable by a machine, tangibly embodying a program of instructions executable by the machine to perform a method for selecting a specific multimedia content segment from a storage medium, the method including:
receiving a wireless signal from a wireless input device in proximity; and
generating a control signal in response to said wireless signal, said control signal directly selecting the specific multimedia content segment from the storage medium.

25. The method of claim 24 wherein said wireless input device comprises an RFID/MFID tag.

26. The method of claim 24 wherein said wireless input device comprises an RF module transceiver.

27. A device for selecting a specific multimedia content segment from a storage medium comprising:
means for receiving a wireless signal from a wireless input device in proximity; and
means for generating a control signal in response to said wireless signal, said control signal directly selecting the specific multimedia content segment from the storage medium.

28. The device of claim 27 wherein said wireless input device comprises an RFID/MFID tag.

29. The device of claim 27 wherein said wireless input device comprises an RF module transceiver.
